(19) United States
(12) Patent Application Publication
(10) Pub. No.: US 2010/0263654 A1
(43) Pub. Date: Oct. 21, 2010

(54) Outdoor Cooker

(76) Inventor: William E. Cusack, Peoria, IL (US)

Correspondence Address: LIELL & MCNEIL ATTORNEYS, PC, P.O. BOX 2417, 511 S. MADISON ST., BLOOMINGTON, IN, 47402, US

(21) Appl. No.: 12/826,857

(22) Filed: Jun. 30, 2010

Related U.S. Application Data
(63) Continuation-in-part of application No. 11/900,934, filed on Sep. 13, 2007.
(60) Provisional application No. 60/849,866, filed on Oct. 6, 2006.
(60) Provisional application No. 61/269,901, filed on Jun. 30, 2009.
(60) Provisional application No. 61/293,810, filed on Jan. 11, 2010.

(51) Int. Cl. A47J 37/07; F24B 5/00; A47J 37/04; F23J 11/02

(52) U.S. Cl. 126/25 R; 126/15 A; 99/419; 126/312

(57) ABSTRACT

An outdoor cooker includes a main cooking chamber defined by a base and a lid. A firebox is attached to one end of the base, and an exhaust stack is attached to an opposite end of the base. A venturi air supply has an outlet end that opens into the firebox and an inlet end that opens outside the firebox, and includes a main passage and at least one venturi passage. A blower is attached to the main passage. The firebox also includes an internal divider that divides the firebox into a lower chamber fluidly connected to an upper chamber by flow openings in a burn platform. The firebox includes a first access door with a vertical hinge axis, and a second access door with a horizontal hinge axis. A rotisserie spit support and a motor support are mounted to opposite sides of the second access door.

### RELATION TO OTHER APPLICATIONS

This is a continuation-in-part of application Ser. No. 11/900,934 entitled Outdoor Cooker And Method Of Use filed Sep. 13, 2007, which claims priority to provisional application 60/849,866, filed Oct. 6, 2006 and entitled Meat Monster Cooker. This application also claims priority to Provisional Application No. 61/269,901, filed Jun. 30, 2009, entitled Outdoor Cooker, Systems And Methods For Outdoor Cooking, and Application No. 61/293,810, filed Jan. 11, 2010 with the same title.

### TECHNICAL FIELD

The present disclosure relates generally to outdoor cookers, and more specifically to a multiple configuration outdoor cooker that can include a forced air venturi air supply.

### BACKGROUND

Outdoor cooking is among the favorite pastimes of many. As such, the methods and equipment for doing so are considerably diverse. Cookers vary greatly in size from small, portable units to large commercial systems designed to feed hundreds. Cookers further vary in purpose; some are merely to grill the food while others add a means to smoke the foods to provide varying flavors. There is also considerable diversity in the fuel sources used to provide heat; natural or propane gas, charcoal, and wood are all types of combustible fuels used. Some cookers combust the fuels directly below the food while others offset the fuel source for indirect cooking. While traditional cooker designs have performed well for decades, there remains room for improvement.

It has been discovered that air flow into and out of outdoor cookers can be controlled to enhance or tailor the cooking experience. The circulation of air and other gasses inside an outdoor cooker can also affect the quality and enjoyability of the cooking process. State-of-the-art systems, however, tend not to have readily controllable mechanisms for air supply, exhaust, and in-chamber circulation.

Outdoor cookers also tend to be relatively difficult to clean, as drippings, ash and other debris from the cooking process can accumulate within an outdoor cooker body but are typically not readily removable. There is a further need for improved flexibility and user selection of the manner in which a given outdoor cooker can be used in any particular instance. For example, it has become commonplace for a separate firebox to be used, which is positioned adjacent to and in fluid communication with a main cooking chamber. However, there are instances where use of combustibles directly in the cooking chamber is desired. Standard systems are often purpose built for one or the other of these general techniques, and do not adequately support the use of alternative cooking mechanisms and/or strategies. Still other shortcomings relate to the difficulty in raising and lowering the relatively heavy lids used with certain cooker designs.

In recent years, outdoor cooking tournaments and festivals have become commonplace. A traditional outdoor cooker might include a receptacle which serves to contain burning wood, charcoal, etc., while a grate is positioned over the burning combustibles and supports food to be cooked thereon. A lid is typically used to provide an enclosed cooking chamber. To enhance mobility and ease the transport of outdoor cooking equipment, relatively larger cookers are mounted on trailers to be towed via a tow vehicle. The sight of numerous, sophisticated trailer mounted outdoor cookers at parks and other recreation areas will be familiar to those skilled in the art. While traditional designs have worked well for decades, recent developments in outdoor cooking research and technology have revealed the potential for still further improvements.

One known outdoor cooker design includes a main cooking chamber coupled with, and fluidly connected to, a firebox, having an attached blower to supply combustion air. This design can provide some user control over combustion rate and cooking temperature. Certain other designs utilize exhaust fans to assist in drawing gases out of the main cooking chamber. These techniques have improved over traditional outdoor cooker designs where passive air in-flow and exhaust outflow strategies were used. There is nevertheless room for further improvement, particularly with regard to control over the supply of combustion air and resulting cooker operating characteristics.

Today's consumers also often demand great versatility from outdoor cookers. For instance, some gas grills have multiple burners to permit direct grilling, indirect cooking, and may even include a rotisserie accessory for slowly turning of meat over a direct or indirect heating source. Other desired techniques include slow, low temperature smoking of food products, medium heat barbecuing, and of course high heat direct grilling. While some gas grills provide versatility and convenience, most consumers prefer the enhanced flavor provided by charcoal and wood. In addition, a consumer often desires versatility with regard to cooking space, as some entertaining requires cooking relatively large amounts of food, whereas others require cooking for only one or two persons. Providing an outdoor cooker with more versatility without sacrificing controllability has proven elusive.

The present disclosure is directed toward one or more of the problems set forth above.

### SUMMARY OF THE DISCLOSURE

In one aspect, an outdoor cooker includes a main cooking chamber defined by a base and a lid. A firebox is attached to one end of the base of the main cooking chamber, and an exhaust stack is attached to an opposite end of the base. A venturi air supply includes an outlet end that opens into the firebox and an inlet end that opens outside the firebox. The venturi air supply includes a main passage and at least one venturi passage. The venturi passage is configured to generate a venturi flow into the firebox when air flows through the main passage into the firebox. The main passage has a supply port sized for connection to a forced air supply device.

In another aspect, an outdoor cooker includes a main cooking chamber defined by a base and a lid. A firebox is attached to one end of the base, and an exhaust stack is attached to an opposite end of the base of the main cooking chamber. The firebox includes a burn platform and an internal divider that divides the firebox into a lower chamber fluidly connected to an upper chamber by flow openings in the burn platform. An air supply passage opens into the lower chamber, and the upper chamber opens into the main cooking chamber.

In still another aspect, an outdoor cooker includes a main cooking chamber defined by a base and a lid. A firebox is attached to one end of the base, and an exhaust stack is attached to an opposite end of the base of the main cooking chamber. The firebox includes a first access door with a vertical hinge axis, and a second access door with a horizontal hinge axis. A rotisserie spit support and a motor support are mounted to opposite sides of the second access door.

### BRIEF DESCRIPTION OF THE DRAWINGS

FIG. 1 is a perspective back view of an outdoor cooker according to one aspect of the present disclosure;

FIG. 2 is a close up perspective view of a lid spring tension adjustment device corresponding to enlargement 2 of FIG. 1;

FIG. 3 is a partially sectioned end view of an outdoor cooker according to another aspect of the present disclosure;

FIG. 4 is an enlarged perspective view of the connection between the grate lifting device and the cooking surfaces for the main cooking chamber according to another aspect of the present disclosure;

FIG. 5 is a perspective view of a firebox for an outdoor cooker having a venturi air supply according to another aspect of the present disclosure;

FIG. 6 is a sectioned view through the venturi air supply of FIG. 5 as viewed along section line 6-6;

FIG. 7 is a perspective end view of a firebox according to another aspect of the present disclosure;

FIG. 8 is a view inside a firebox of an outdoor cooker according to another aspect of the present disclosure;

FIG. 9 is a detail section view inside the firebox of FIG. 8 as viewed along section lines 9-9;

FIG. 10 is a front sectioned view of an outdoor cooker according to still another aspect of the present disclosure; and

FIG. 11 is a perspective side view into the firebox of the cooker of FIG. 10.

### DETAILED DESCRIPTION

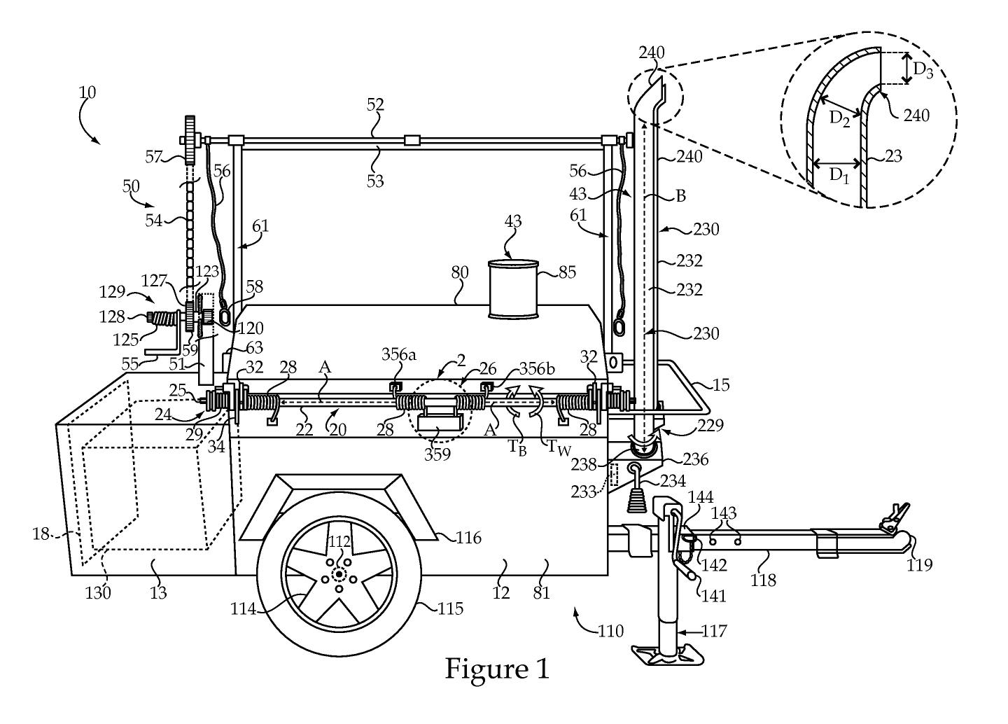

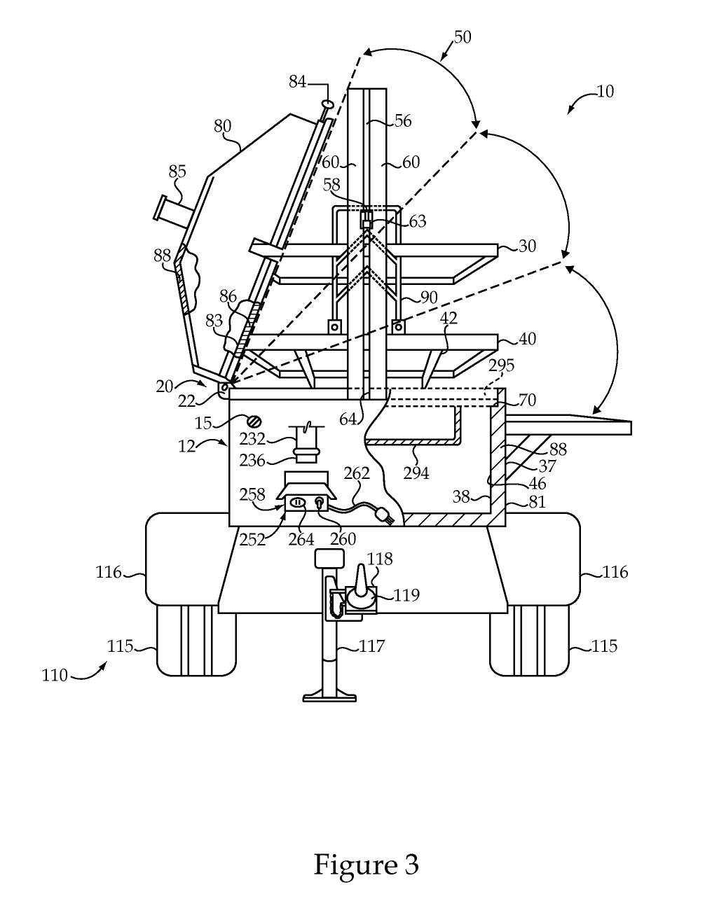

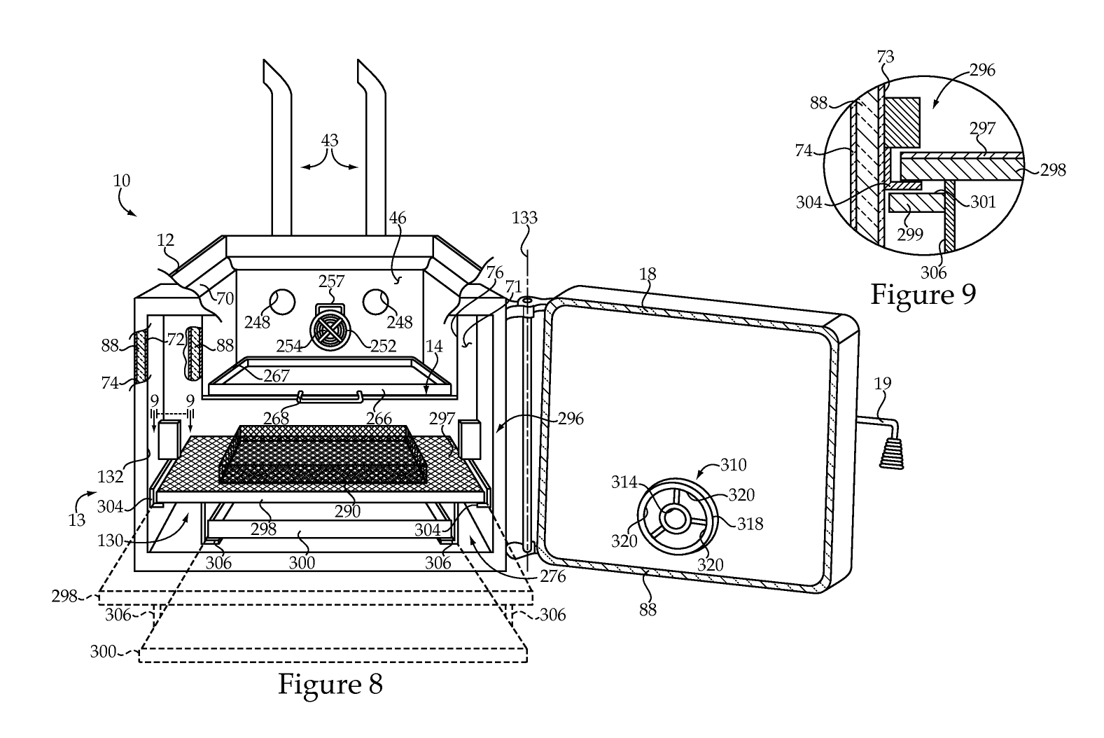

FIG. 1 shows a perspective back view of an outdoor cooker 10. The outdoor cooker 10 comprises an outdoor cooker body 12, which in one embodiment may be mounted upon a trailer chassis 110. Outdoor cooker body 12 includes a base 81 and a lid 80 that together define a main cooking chamber 46 (FIGS. 3, 8 & 10). FIG. 3 shows a perspective end view of a portion of outdoor cooker 10, and in particular cooker body 12. Cooker body 12 may be double walled, including an inner wall 38 and an outer wall 37, and insulation material 88 being positioned between inner wall 38 and outer wall 37. Attached to the outdoor cooker body 12 at one end of base 81 may be a double-walled firebox 13 containing an inner firebox wall 72 and outer firebox wall 74, as best shown in FIG. 8. Between the inner firebox wall 72 and outer firebox wall 74 may be placed firebox insulation 88, which may be comprised of ceramic high-temperature insulation. The double-walled firebox 13 may have attached a firebox door 18 which may cover an opening to the double-walled firebox 13. Access to within the double-walled firebox 13 may be gained by opening the firebox door 18 about a vertical axis 133 using a handle 19. This access inside the double-walled firebox 13 may allow the cooker user to be able to build and maintain a fire within the double-walled firebox 13. Those skilled in the art will recognize that the double-walled insulation 88 may or may not be applied further to the firebox door 18.

As mentioned above, the outdoor cooker 10 may be placed upon an outdoor cooker trailer chassis 110. The outdoor cooker trailer 110 may comprise a wheel axle 112 connected to at least one wheel 114 having a tire 115 attached. A wheel fender 116 may also be attached above the wheel 114. The outdoor trailer may also have a removable trailer tongue 118 that slides into or out of a square tube 144. Tongue 118 may be fixed to trailer 110 and one end connected to a tow vehicle via hitch 119 at its opposite end via a removable pin 142. Cooker 10 may be supported by a trailer third wheel or stand 117 that is attached to a square tube 144. The height of stand 117 may be adjusted in a conventional manner with crank handle 141 to level the cooker. Tongue 118 may include a number of pin holes 143 to allow the user to adjust the tongue length to suit a particular tow vehicle geometry.

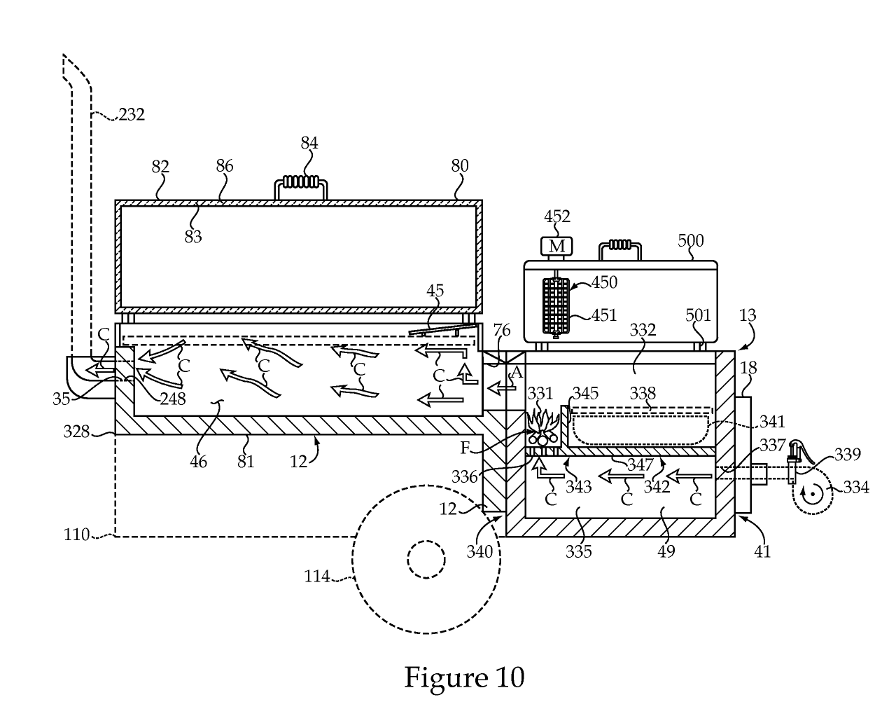

Placed within the outdoor cooker body 12 near the opening from the firebox 13 into the outdoor cooker body 12 may be a removable deflection plate 45 (FIG. 10) under which heat and gases from the burning of a combustible fuel source within the firebox 13 may pass before being dispersed towards the center of the main cooking chamber 46 of outdoor cooker body 12. The deflection plate 45 may further be placed upon a cooker rack or the floor of base 81.

In one embodiment, lid 80 may have a lid handle 84 as shown in FIGS. 3 & 10. The lid 80 may also have a thermometer (not shown) mounted upon the lid in order to monitor temperatures within the main cooking chamber. The lid 80 may include a U-shaped channel 83 that receives a flexible high temperature fiberglass rope seal 86 along the edges of the lid 80, enabling lid 80 to quietly contact the base 81 when the lid 80 is in a fully closed position, at which position a nearly airtight seal may be made. For instance, fiberglass rope 86 may be positioned in a U-shaped channel 83 defined by the peripheral edge of the lid 80. By facilitating a seal around at least a portion of the peripheral edge of the lid 80, leakage and the associated temperature variations within the cooker may be reduced. This also permits finer control of temperature and heat flow by the operator.

FIG. 3, depicts outdoor cooker 10 where lid 80 has been raised. As described above, lid 80 may include a double walled lid having a layer of ceramic insulation 88 positioned between an internal wall and an external wall of lid 80. Lid 80 may be attached to base 81 of outdoor cooker body 12 by a pivot attachment 20 having a pivot bar or rod 22 that may pass through a lid hinge arm 32 and body hinge arm 34 along a pivot axis A, as best shown in FIG. 1. A biasing device(s) 26 such as a torsion spring(s) 28 with a torsion preload may be mounted about the pivot bar 22 and connected at one end to the base 81 and connected at the other end to the cooker lid 80 to supply a biasing torque T_{B} tending to counteract a weight torque T_{W} of lid 80 about pivot axis A.

In one embodiment, a rotational friction or neutral stop braking device 24, which includes a compression spring 29, may be mounted about the pivot bar 22 to apply a force to a friction plate to increase friction when lid 80 rotates about bar 22. A pre-load on the compression spring 29 may be adjusted by rotating a locking nut 25 or other spring adjuster mechanism, towards or away from the compression spring 29. By adjusting the friction in neutral stop mechanism 24 via locking nut 25, the difference between the biasing torque T_{B} and the weight torque T_{w} can be overcome so that lid 80 may be stopped at any of a continuum of different partially open positions, as best shown in FIG. 3. In many instances, compression spring 29 can be omitted because the spring lift system (springs 28) are so effective is managing the lifting weight that the compression neutral stop is not needed.

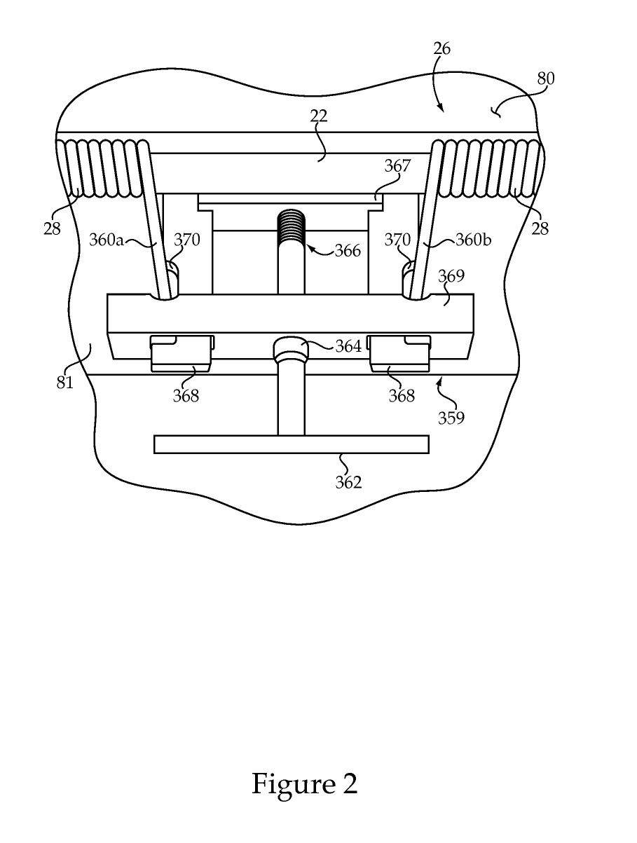

Referring now in particular to FIGS. 1 and 2, there are shown biasing mechanism 26 and a lid spring adjustment device 359 configured to adjust an opening bias on lid 80. It has been discovered that persons using outdoor cookers may wish to have an adjustable bias for the lid of an outdoor cooker for various reasons. In some instances, it is desirable to create a disincentive for unauthorized persons to open the lid of an outdoor cooker, for example when a user leaves the outdoor cooker for a period of time. In such instances, it may be appropriate to provide zero or even a negative opening bias on an outdoor cooker lid, and instead allow the full weight of the lid to hold it in place. In other instances, for example where a user is frequently accessing the interior cooking chamber of an outdoor cooker to manipulate, remove or add food being cooked, it may be desirable to have a significant opening bias on the lid such that the user can readily open the lid without having to lift its full weight. Biasing mechanism 26 may further include one or more lid springs 28, which are configured to apply an opening biasing force on lid 80. In particular, each lid spring 28 may include a first spring end 356a and 356b, respectively, coupled with lid 80. Each of lid springs 28 may further include a second spring end 360a and 360b which is received in a base bracket 367 attached to cooker body 12. Base bracket 367 may include a set of base extension plates 368 which protrude outwardly from cooker body 12. Each of base extension plates 368 may include a slot 370 formed therein which receives second spring end 360a and 360b. A tensioning bar 369 may be provided which abuts each second spring end 360a and 360b. Lid spring adjustment device 359 may be configured to adjust a position of tensioning bar 369 relative to cooker body 12, thereby varying a relative non-axial tension on each lid spring 28. In other words, by moving tensioning plate 368 relatively closer to cooker body 12, springs 28 may be twisted to a relatively tighter tension state. The opposite will also be the case, where tensioning bar 368 is moved relatively further from cooker body 12 to relieve tension on springs 28. A T-screw 362 is provided which includes a threaded end 366 received in a threaded bore in base bracket 367. T-screw 362 may include a collar 364 which abuts tensioning bar 368. Rotation of T-screw 362 may, via threaded engagement with base 367, draw T-screw 362 and thus collar 364 relatively closer to cooker body 12, or relatively further from cooker body 12, in turn varying a position of tensioning bar 368 to control the extent to which springs 28 are tensioned. Although in FIGS. 1 and 2 only one centrally located lid spring adjustment device 359 is shown. It is contemplated that multiple lid spring adjustment devices might be used for an outdoor cooker, for instance one positioned toward each of opposite ends of lid 80.

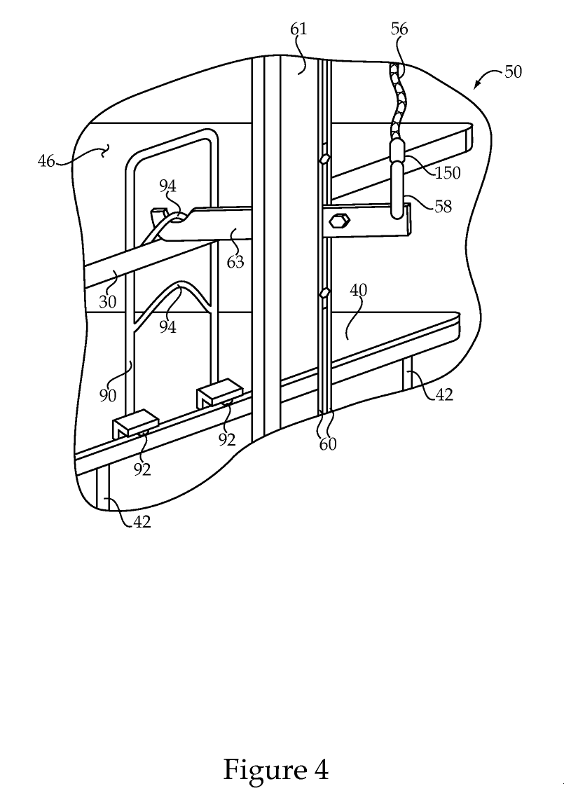

Referring also to FIG. 4, in one embodiment outdoor cooker 10 may include a lifting mechanism 50 attached to the outdoor cooker body 12, for raising and lowering cooking surfaces into and out of base 81. Lifting mechanism 50 may include an axle 52 and a supporting cross-bar 53 connected to a vertically oriented guide 61. The vertically oriented guide 61 may further be comprised of two pairs of parallel guide rails 60, which may be L-shaped rails mounted parallel to a vertical travel direction of cooker racks 30 and 40. An oriented plate 63 may pass in between a pair of guide rails 60, and support racks 30 and 40.

An upper sprocket 57 may be attached at one end of the axle 52. A lower sprocket 59 may be located below the upper sprocket 57 and supported by a lower sprocket support 51. A lifting chain 54 may operably connect the upper sprocket 57 to the lower sprocket 59. A crank handle 55 may be operably attached to the lower sprocket 59 as to rotate the axle 52. A cable 56 may also be operably attached to wind about the axle 52, and alternatively raise or lower plate 63 to adjust a vertical position of racks 30 and 40. FIG. 1 also shows a lifting mechanism neutral stop braking device 129. A lifting mechanism axle 127 that may be mounted onto the lower sprocket support 51 by a lifting mechanism nut 120, such that the lifting mechanism axle 127 is rotatably fixed relative to the lower sprocket support 51. The lower sprocket 59 and handle crank 55 may be mounted on the lifting mechanism axle 127. At one end of the lifting mechanism axle 127 may be mounted a compression spring 125 that may apply an axial sandwiching force to increase friction among components of mechanism 50, allowing racks 30 and 40 to be stopped at any lift height. In other words, any rack lifted can be stopped at any vertical position, and will stay suspended due to the action of the neutral stop braking device 129. A nut 128 allows the preload on lifting mechanism spring 125 to be adjusted, which allows the friction level to be increased or decreased.

As mentioned above, a cable 56 or a pair of cables 56 may be attached to helically wind upon the axle 52. The cable 56 may have a connective device such as a carabiner 58 attached at one end. Carabiner 58 may be capable of being connected to, and disconnected from, the vertically oriented plate member or hook 64 (FIG. 4). The cable 56 may be further attached to the axle 52 at a location horizontally offset from the connection between carabiner 58 and plate 64 to promote tight helical winding in a single layer or successive layers about axle 52. This provides the benefit to a cooker user by causing the cable 56 to wrap inward in a helical pattern as the axle 52 is rotated, eliminating kinks, bunching, and abrupt movements that may otherwise occur if the cable wound onto itself.

The outdoor cooker 10 may further include a first configuration, having upper cooker rack 30 resting upon a ledge 70 adjacent a top of the base 81, and a plurality of prop rails 42 of lower rack 40 upon resting upon a bottom surface 14 of the outdoor cooker body 12. In this configuration, lid 80 may be completely closed. The outdoor cooker 10 may further have a second configuration where the upper cooker rack 30 is suspended from the lifting mechanism 50 above base 81 of the outdoor cooker body 12, and the lower cooker rack 40 is decoupled from lifting mechanism 50 and rests upon bottom surface 14 of the outdoor cooker body 12. The outdoor cooker 10 may still further have a third configuration where the upper cooker rack 30 is suspended from the lifting mechanism 50 above the base 81, and the lower cooker rack 40 is suspended from the lifting mechanism 50 above bottom surface 14 by being coupled to plate(s) 63 by a coupler 90 (FIGS. 3 & 4). The coupler 90 may further include a plurality of vertically spaced V-shaped bars 94 coupled between plate 63 and racks 30 and 40 for setting a separation distance between the upper cooker rack 30 and the lower cooker rack 40. Coupler 90 also includes hooks 92 for connection and disconnection to lower rack 40.

Those skilled in the art will recognize that one or more smokestacks 85 are attached to the cooker lid 80 as shown in FIGS. 1 and 3. Smokestack 85 may be equipped with a swivel cover plate or some other valve mechanism or the like (not shown) to adjust the size of an opening through the smokestack, or to close the same completely. Air and smoke flow through the cooker body 12 may also be controlled via vertical exhaust stacks 230 that fluidly connect with and open into base 81 at an end opposite to that of firebox 13.

A fire basket 290 (FIG. 8) for placing and burning combustible fuels, which may include a receptacle enclosed by metal mesh on five of six sides, with the sixth side open for access to the combustible fuels, may be placed within the firebox 13 to contain debris from a combustible fuel source. One location of many within the firebox 13 upon which the fire basket may be placed is upon an elevated grate 298.

A plurality of different surfaces and designs may be used to form the cooking surfaces upon the cooker racks described herein. Such surfaces may include, for instance, steel mesh grate, steel rods, stainless steel mesh grate, and stainless steel rods. While the outdoor cookers described herein may be of an intermediate size, having dimensions around twenty-four inches by sixty inches, and a cooker lid weight of around 120 pounds, those skilled in the art may recognize that the capabilities and features contemplated herein may apply to outdoor cookers regardless of dimension or weight.

FIGS. 3 and 8 illustrate a convection fan 252 installed in the base 81 of cooker body 12. Convection fan 252 may be configured to provide or enhance air circulation within cooking chamber 46, and may include a fan housing 257 wherein a rotatable electrically powered fan is positioned. A set of exhaust vents 248, connecting with other components of exhaust system 43, are also visible in FIG. 8 and fluidly connect with cooking chamber 46. A motor housing 258 for convection fan 252 may include an electric motor connectable with an electrical power source, such as a generator or an electrical grid, by way of an electrical cable 262. An auxiliary electrical outlet 264 may be made available in motor housing 258 for connecting other electrically powered components as desired. A switch 260 is also shown in motor housing 258, and may be used to turn convection fan 252 on or off as desired. In other embodiments, convection fan 252 might not be used, and in still further embodiments convection fan 252 may be an available option which can be positioned in cooker body 12 to place fan housing 257 within cooking chamber 46. A plate or the like may be provided to block the opening used to accommodate convection fan 252 when it is removed from cooker body 12 and not used, or not provided as an option in a commercial embodiment. Those skilled in the art will appreciate that convection fan 252, or other convection fans and air circulation/handling components of outdoor cooker 10 might be positioned at various locations, depending upon desired effect during cooking.

In FIG. 8 there is shown a clean-out tray 266 positioned within cooker body 12. Clean-out tray 266 may include a rectangular configuration, having raised edge walls 267, which are vertically oriented and allow grease drippings and other debris to be collected during use of outdoor cooker 10. Clean-out tray 266 may include a tray handle 268, whereby clean-out tray 266 can be removed from outdoor cooker 10, through firebox 13 for example. In the embodiment shown, tray 266 may be pulled completely out of outdoor cooker 10 and sprayed off, dumped, etc., then repositioned within outdoor cooker 10 for future service. The use of clean-out tray 266 is contemplated to provide various advantages over state of the art systems, where grease, debris, etc., is allowed to collect inside an outdoor cooker, but no easy mechanism for clean-out is provided. In prior systems, the interior of an outdoor cooker had to be sprayed, scraped, swept or otherwise laboriously cleaned to remove grease, debris, etc., from a cooking operation. In addition, allowing clean-out tray 266 to be removed via firebox 13 provides an easy mechanism for sliding tray 266 out of outdoor cooker 10. Firebox door 18 may be opened, and, once outdoor cooker 10 is sufficiently cooled, clean-out tray 266 may be slid out and cleaned, etc., as described herein. Also shown in FIG. 8 is a firebox combustion space 71 through which clean-out tray 266 is passed when sliding the same into outdoor cooker 10 or removing the same therefrom. Clean-out tray 266 may have a rectangular footprint matched in size and shape with cooking chamber 46 in one embodiment. When positioned fully within cooker body 12, tray 266 may rest on bottom surface 14 of base 81.

FIG. 8 also illustrates components of a charcoal handling system 296. Charcoal handling system 296 may include a rack 298 positionable in firebox combustion space 71, and having basket 290 supported thereon. Basket 290 may be a separate component, and used to contain combustibles such as charcoal, wood, etc., for burning within firebox 13 as discussed above. Charcoal handling system 296 may also include a slide-out tray 300 which fits underneath rack 298. Rack 298 and slide-out tray 300 may each be slideable in and out of firebox 13 independently of one another. Slide-out tray 300 may be used to catch ashes from burning combustibles contained in basket 102. In one embodiment, slide-out tray 300 may be guided via tray guide rails 306 which are part of rack 298. Rack guide rails 304 may also be provided, and may be welded to an inside of firebox 13 to guide rack 298 during sliding in or out of firebox 13. A cantilever support strategy may be used to support rack 298 and tray 300 in the position shown in FIGS. 8 and 9. The close-up view of FIG. 9 shows a portion of rack 298 having an extension 299 which is used to support rack 298 when slid partially out of firebox 13. Extension 299 may include an upper surface 301 which engages against an underside of rail 304 when rack 298 is slid partially out of firebox 13. A similar extension may be provided on an opposite side of rack 298, resulting in a cantilevered support mechanism which allows charcoal handling system 296 to be positioned at an easy access location/orientation, partially outside of firebox 13. During use, charcoal handling system 296 will typically be kept within firebox 13; however, for clean-out or other purposes various components of charcoal handling system 296 may be easily accessed in an approximately thigh-high location when slid out, approximately as shown in phantom in FIG. 8.

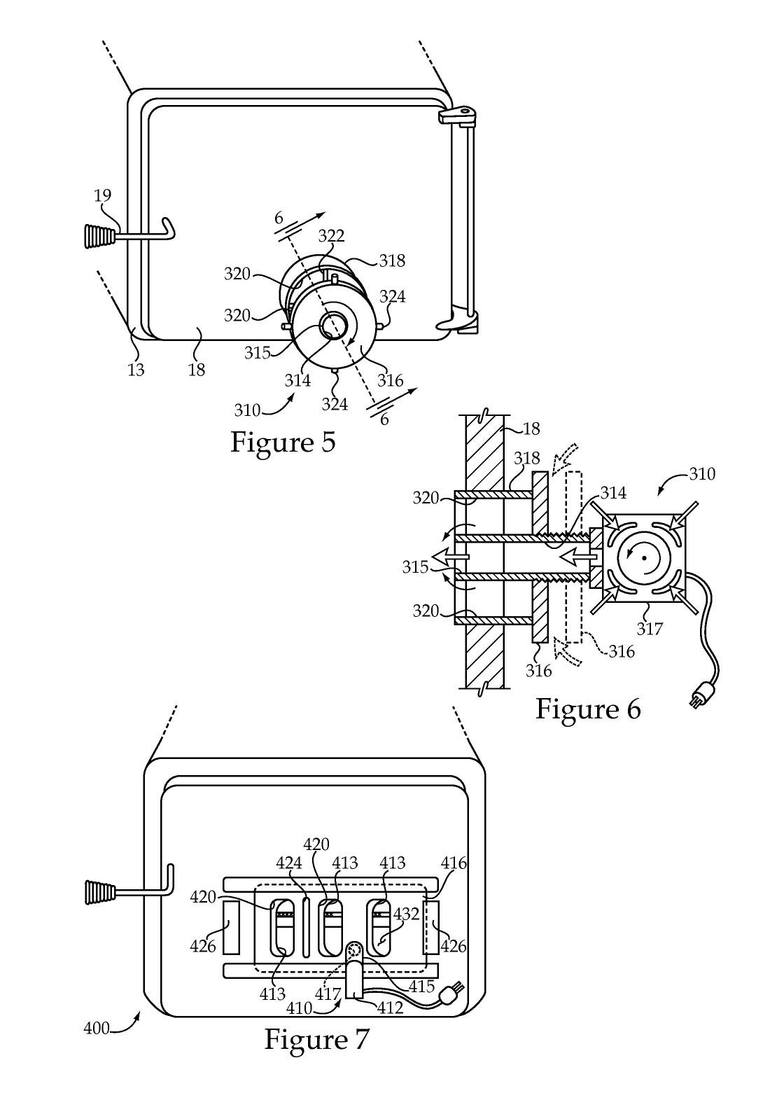

Turning in addition to FIGS. 5-6, there is shown a view of outdoor cooker 10 illustrating firebox 13 equipped with a forced air system 310, which is shown as a venturi air supply. Forced air system 310 can enable ambient air to be blown via a main passage 314 formed in a tube 315 into combustion space 71 of firebox 13. Forced air system 310 may include certain components configured for adjusting venturi-enhanced air delivery. To this end, forced air system 310 may further include a shell tube 318 that surrounds tube 315 and extends through firebox door 18, and includes a plurality of secondary venturi passages 320 which are positioned radially about and partially defined by tube 315, and separated from one another via a web 322. Air blown through tube 315 can create a venturi effect, which draws additional air through ports 320 into firebox 13. A venturi flow adjuster plate 316 may be provided which is positionable along a continuum of axial locations on tube 315 to vary a relative size of openings to ports 320 and, hence, vary a quantity of venturi air drawn through ports 320. Those skilled in the art will appreciate that the present disclosure encompasses other venturi passage configurations besides that shown.

Referring specifically to FIGS. 6 and 10, there is shown an electrically powered fan 312 or any other suitable electrical blower coupled with tube 315. It may be noted that tube 315 may be externally threaded. Tube 315 may also be internally threaded to enable coupling with fan 312, which may be threadedly received therein. Plate 316 may include a set of lugs 324, welded to a periphery thereof for example, which allow plate 316 to be easily rotated by hand relative to tube 315. Plate 316 may be internally threaded and mated to external threads 315, hence rotation of plate 316 can vary its relative axial position along a central axis of tube 315. Plate 316 is shown in FIG. 6 rotated approximately to a closed position at which it contacts shell tube 318 to completely block ports 320. In this configuration, the only air supplied into firebox 13 will be air blown inward by way of fan 312 through tube 315. When plate 316 is positioned approximately in the location shown in FIG. 5, out of contact with shell tube 318, air passed through tube 315 by fan 312 will draw additional venturi air into firebox 13 via ports 320 according to the venturi effect. Fan 312 may be fixed or variable speed. In the configuration shown in FIG. 5, forced air system 310 is shown with plate 316 approximately in a fully open position. A range of locations of plate 316 relative to tube 315 may exist between the position shown in FIG. 5 and the position shown in FIG. 6, corresponding to a continuum of partially open positions. This allows the forced air supply to firebox 13 to be varied without the need for adjusting fan speed. Returning to FIG. 8, there is shown a view of ports 320 and 314 as they would appear from an inside of firebox 13. Firebox door 18 is shown in an open position, wherein the radial positioning of ports 320 and the location and configuration of web 322 is readily apparent. The web configuration, numbers of intake ports, etc., might be varied from the general configuration shown without departing from the scope of the present disclosure. In addition, venturi air supply 318 need not necessarily be mounted in door 18, and might instead be mounted through a wall of firebox 13, for instance.

Referring now to FIG. 7, there is shown a view of an outdoor cooker 400 having a firebox 432 and a forced air system 410 according to another embodiment. Forced air system 410 includes an electrically powered fan 412 coupled with a tube 415 which is in turn coupled with a firebox 432. Forced air system 410 includes a slidable plate 416 having a handle 424, and a plurality of apertures 420 formed in plate 416. In the configuration illustrated in FIG. 7, forced air system 410 is in a partially open position, such that the air supply into firebox 432 will be that provided by operating fan 412 and also that provided via partially open apertures 420. Plate 416 may be moved to a fully open position, where apertures 420 align in register with apertures 413 formed in firebox 432, or to be closed position where the sole air supply is via tube 415. It may be noted that stops 426 are positioned on either side of plate 416, to restrict the range of motion. A variety of different positions of plate 416 may be used to vary the relative amount of air passing into firebox 432.

Referring again to FIG. 1, there is shown a portion of an exhaust system 229, including a detailed partial section view, suitable for use with any of the outdoor cooker embodiments described herein. Exhaust system 229 may include an exhaust stack 230 which includes an exhaust pipe 232 rotatable about an axis B relative to a base 236. Exhaust stack 230 is attached to an end of base 81 opposite to the end to which firebox 13 is attached. In one embodiment, exhaust pipe 232 may be one of two exhaust pipes, the other of which is partially obscured. Exhaust pipe 232 may be manually rotatable, and might be equipped with a bearing (not shown), for example, between base 236 and exhaust pipe 232 to enable smooth rotation. A handle 234 may be provided which is operable to open or close a butterfly valve 233 between a cooking chamber of the associated outdoor cooker and exhaust stack 230. A similar handle may be provided for a second exhaust stack where used. Exhaust stack 230 may include an upstream end 238, positioned adjacent base 236 in one embodiment, and is downstream end 240. It may be noted that downstream end 240 is relatively narrower than upstream end 238. Exhaust stack 230 may include a narrowing taper in a direction towards downstream end 240. To this end, exhaust stack 230 may include a first diameter D₁, which includes a diameter for a majority of an axial length of exhaust stack 230, a second diameter D₂ which is relatively narrower than first diameter D₁, and a third diameter D₃ which is narrower still at downstream end 240. Providing a narrowing taper in a direction of downstream end 240 allows exhaust flowing out of exhaust stack 230 to experience an enhancement of flow rate due to a venturi effect of ambient air passing over the narrowing taper. In other words, wind blowing past exhaust stack 230 will tend to accelerate as it passes about the corresponding narrowing taper, resulting in a suction force that assists in pulling exhaust through the corresponding exhaust stack and out downstream end 240. By providing for rotation of exhaust stack 230, exhaust stack 230 may be positioned such that downstream end 240 is at a location downwind relative to prevailing air currents. In this general manner, rotation of exhaust stack 230 may be used to assist in providing air flow through an associated outdoor cooker. It may also be noted that one of the two illustrated exhaust stacks 230 may extend vertically higher than the other, and thus its downstream end may be vertically higher than the downstream end of the other exhaust gas. The upstream end 238 of one of exhaust stacks 230 may also connect with cooker body 12 at a location which is vertically higher than the upstream end of the other of exhaust stacks 230. Ports 248 in FIG. 8 illustrate such a configuration. Since exhaust stack 230 may be equipped with a butterfly valve or damper, as mentioned above, the manner in which gasses flow through the associated cooker can be varied by controlling the butterfly valve(s) of the one or more exhaust stacks 230. For example, where greater exhaust flow along the bottom of cooking chamber 46 is desired, the lowermost port 248 might be opened while the uppermost port is closed or restricted. Where relatively uniform exhaust flow through cooking chamber 46 is desired, both butterfly valves might be placed in an open position, and so on.

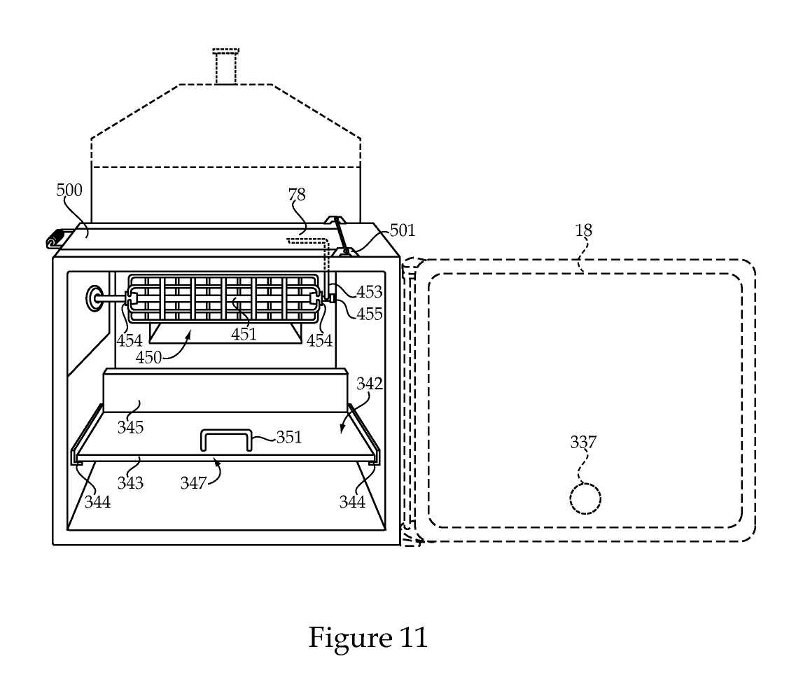

In still another embodiment shown in FIGS. 10 and 11, various components may be positioned within firebox 13 to enable cooking therein. In particular, a firebox grill 338 may be mounted within firebox 13 and configured to support food for cooking thereon. A combustion airflow directing divider 342 of a combustion system 330 may also be positioned within firebox 13 and configured to direct combustion air up through firegrate or burn platform 336, and a cooking fire F located in a combustion space 331. While cooking within firebox 13 may occur simultaneously with cooking in main cooking chamber 46, cooking of food might take place in firebox 13 alone, or in main cooking chamber 46 alone. In one embodiment, firebox combustion space 331 may be defined in part by internal airflow directing divider 342, in part by cooker body 12 and in part by fire grate 336. Example use and features of airflow directing divider 342, as well as other components positioned within firebox 13, will be further apparent from the following description.

Referring now specifically to FIG. 10 there is shown a partially sectioned side diagrammatic view of outdoor cooker 10, omitting certain of the features shown in FIG. 1 for clarity. As alluded to above, airflow directing divider 342 may be used to direct combustion air through firebox 13 in a desired manner. In one embodiment, airflow directing mechanism 342 may include an airflow control plate 347 having an L-shaped configuration which includes a vertical plate 345 and a horizontal plate 343. Each of plates 345 and 343 may include flat plates of steel or the like, joined at a bend formed via a brake, or welded together. Vertical plate 345 may be relatively shorter than horizontal plate 343, although the present disclosure is not thereby limited. In the illustrated embodiment vertical plate 345 separates combustion space or burn area 331 from a secondary cooking chamber having firebox grill 338 positioned therein. The horizontal plate 343 separates the secondary cooking chamber from lower chamber 335. Airflow control plate 347 may be supported within firebox 13 at a location which is vertically above an air inlet or intake port 337 connected with combustion air supply mechanism 334. Airflow control plate 347 may further include a horizontal length (length of leg 343) which is equal to at least a majority of a length of firebox 13 in a horizontal direction between door 18 and base 81. Fire grate 336 may be supported in firebox 13 and mounted horizontally between airflow control plate 347 and body 12. The airflow control plate 347 and fire grate 336 together divide firebox 13 into upper chamber 332 and a lower chamber 335. The chambers are fluidly connected by floor openings through fire grate 336 in the illustrated embodiment. The air supply opens to lower chamber 335, while space 331 of upper chamber 332 opens to main cooking chamber 46, thus imparting an air flow pattern shown in FIG. 10 via arrows C.

Airflow control plate 347 may include a shape and dimensions such that it fits relatively snugly within firebox 13. For instance, a width of each of legs 345 and 343, in a direction perpendicular the page in FIG. 10, may be matched to an inside width of firebox 13 in the same direction. Such a configuration will reduce or inhibit entirely any leaking of incoming combustion air vertically upward between edges of plate 347 and inside walls of firebox 13. It is contemplated that a true fluid seal between plate 347 and inside walls of firebox 13 will not be necessary, however, fluidly sealing plate 347 with inside walls of firebox 13 might be undertaken. In addition, while plate 347 will typically be removable from firebox 13 via handle 351, as further described herein, in other embodiments plate 347 might be permanently attached to firebox 13, such as by welding.

Operation of combustion air supply mechanism 334 may blow combustion air through intake passage 332 in a direction generally indicated by way of a set of the illustrated arrows C. It may be noted that combustion air passing through lower chamber 332 will initially travel in a generally horizontal direction, but will then flow vertically upward through flow openings in fire grate 336 and thenceforth through cooking fire F which is supported on grate 336. It may be noted that cooking fire F may be located within space 331. From cooking fire F, combustion gases and heat may travel from upper chamber 332 of firebox 13 into main cooking chamber 46 by way of a connecting passage 76. Within main cooking chamber 46, combustion gases and heat may travel generally horizontally towards exhaust outlet 248. An exhaust fan or the like might be fluidly connected with an exhaust outlet 248 to assist in drawing gases through main cooking chamber 46, and also assisting in pulling combustion air into firebox 13 from inlet 337.

As alluded to above, cooking may take place within firebox 13. To this end, a set of drip trays 341 or the like may be positioned within firebox 13, below grill 338 such that they catch drippings, debris, etc., which falls from food supported on grill 338 during cooking In the embodiments shown, drip trays 341 are supported on horizontal leg 343 of airflow control plate 347. FIG. 11 shows firebox 13 having grill 338 and trays 341 removed. It may be noted that horizontal leg 343 provides a flat supporting surface upon which trays 341 may be positioned. In other embodiments, the use of grill 338 and tray 341 might not be desirable, and cooker 10 could be operated without grill 338 and tray 341 positioned in firebox 13. A handle 351 may be coupled with horizontal leg 343 in one embodiment such that plate 347 may be removed when desired. To this end, a set of supports 344 may be mounted to an inside wall of firebox 13 and provide a means for supporting airflow control plate 347 within firebox 13, and can slidingly support plate 347 during removal or placement. Supports 344 may include L-shaped rails welded to inside walls of firebox 13 in one embodiment.

Earlier design strategies for outdoor cookers have often failed to recognize the importance and certain effects of the manner in which air is supplied to a cooking fire. While it has long been known that increasing the air supply to a cooking fire can generally increase the fire's intensity and, hence, heat produced. However, conventional designs do not appear to recognize the role that air can play in actually cooling a fire and associated cooker. For example, blowing air through a combustion space can indeed provide more oxygen to a cooking fire, but an excess of air, which then may bypass the fire, can actually extract heat and confound attempts to achieve a desired cooking temperature. Thus, cooks may attempt to raise the cooking temperature in an outdoor cooker by increasing airflow, but actually end up cooking at a cooler temperature due to the heat extracting properties of excess air. This can be especially problematic in automated systems that turn on the blower responsive to a sensed temperature in the cooking chamber dropping below a set threshold trigger temperature. The excess air from the blower then causes a further temperature drop, resulting in the controller calling for still more excess air. Efficiency, and the logic of the controller is lost when excess air is not used by the fire, because the excess may result in a net lowering of temperature in the cooking chamber. This undesirable cyclic phenomenon is avoided by channeling all incoming air up through the fire according to the present disclosure. The present disclosure recognizes that increasing temperature in the cooking chamber is accomplished by increasing air supply to the fire, which is different from merely increasing air supply to the firebox. The present disclosure leverages a deeper understanding of the behavior of cooking fires in a relatively closed system such as an outdoor cooker. Airflow control divider 342 allows substantially all of the inflowing combustion air to be directed up through a cooking fire F, such that excess air which is not combusted and bypasses cooking fire F is reduced or nearly eliminated. As a result, varying the supply rate of combustion air to cooking fire F provides a more predictable response. These features are contemplated to provide a cook with greater control over cooking temperature, cooking time, and the quality of the end result than that possible by way of known strategies.

Thus, those skilled in the art will appreciate that various modifications might be made to the presently disclosed embodiments without departing from the full and fair scope and spirit of the present disclosure. For example, the positioning of cooking fire F in firebox 13 might be varied from that shown and described herein. Combustion space or burn area 331 could be made relatively larger or located elsewhere, and the shape, size and/or configuration of airflow directing divider 342 adjusted accordingly. Similarly, while combustion air directing mechanism 342 may include the one-piece L-shaped plate 347 in one embodiment, in other instances a multi-piece design or a plate having a different shape might be used, consistent with the configuration of the associated firebox and desired cooking fire location. For instance, a differently configured firebox might locate the cooking fire elsewhere, and thus a different sized and shaped airflow control plate might be appropriate. Other aspects, features and advantages will be apparent upon an examination of the attached drawings.

With continued reference to FIGS. 10 and 11, another variation on the cooker of the present disclosure is shown in which the firebox not only includes a first access door 18 that rotates about a vertical axis, but also a second access door 500 that rotates about a horizontal axis 501. The second access door 500 may better facilitate cooking on the firebox grate 338, and also help maintain easier access to the burn area 331 for resupplying combustibles. Also, a rotisserie 450 may be included by supporting a rotisserie spit 451 on rotisserie spit bracket 453 mounted to secondary access door 500. The rotisserie 451 may extend through a hole in an end of door 500 to engage a rotisserie motor 452 mounted on an opposite side of door 500. In the illustrations, a basket 454 is mounted to rotate with spit 451. Rotisserie 450 has a horizontal axis when door 500 is closed that is perpendicular to horizontal door axis 501. Rotisserie 450 may be located anywhere in upper chamber 332, and may extend in a plane defined by vertical plate 345. Depending on how a fire is built on grate 336, rotisserie food can be cooked by indirect or direct heat.

### INDUSTRIAL APPLICABILITY

The present disclosure described above relates generally to grills, smokers, and other outdoor cookers; and more specifically, to increasing the adjustability and variability of grills, smokers and other outdoor cookers. By disclosing a mechanism by which a cooker lid is biased towards an open position but may remain partially open in a plurality of positions, a multitude of benefits are provided to the cooker user. These benefits may include complete access by the cooker user to the cooking surface with both hands, the ability to easily adjust the height of the cooker lid 80 without having to adjust a secondary propping device, and the ability of a cooker user to retain heat under the lid 80 by opening the lid 80 partially to work under the lid 80, rather than being required to lift the lid 80 fully, allowing considerable heat to escape.

The amount of heat allowed to escape from under the cooker lid 80 may be further reduced by the use of a high temperature fiberglass seal 86 along a U-shaped edge channel 83 of the cooker lid 80 that contact the cooker body 12 when the cooker lid 80 is in a fully closed position. In other words, both the lid 80 and the cooker body 12 contact peripheral seal 86 when the lid is moved to the closed position. During construction, it may be difficult to get a tight seal around the edges of the cooker lid 80 due to shifting temperatures of the metal when welding. The fiberglass seal 86 being more flexible is able to fill these subtle shifts in alignment, providing a much better fit. The fiberglass seal 86 further provides a benefit to the user by acting as a muffler for noise resulting from contact between the cooker lid 80 and base 81 when the lid 80 is closed. While previous usages of a metal on metal would have resulting in a large clanging sound upon closing to less than an airtight seal; the fiberglass seal 86 is further able to dampen this sound. In an alternative, the seal may be located in the cooker body edge 70 without departing from the scope of the present disclosure.

The present disclosure described herein relates to easing the opening of an outdoor cooker lid 80 by a cooker user. While previous efforts in cooking technologies have taught that it is advantageous to assist a cooker user in opening a cooker lid 80, they all have suffered from similar shortcomings. Some required bulky equipment such as a heavy counterweight or sprockets. All were unable to keep the cooker lid partially open, absent a prop-type mechanism. The present disclosure is capable of allowing a cooker user to variably position a lid 80 for an outdoor cooker 10 by moving a lid 80 from a closed position to a partially open position about a pivot bar 22 pivotally attaching the lid 80 to the base 81 of the outdoor cooker body 12. This may be accomplished by the user lifting the lid 80 while biasing the lid away from a closed position with a biasing device 26. Upon reaching a desired partially open position, the user is able to stop lifting the lid 80 and frictionally maintain the lid 80 in a partially open position against an action of the biasing device 26 and the weight of the lid 102. The biasing devices, such as a compression spring 28 containing a torque pre-load mounted about the pivot bar 22 and attached to the cooker lid 80 and cooker body 12, acts to provide an opening force upon the cooker lid 80, reducing the overall net downward force of the cooker lid resultant from the cooker lid's weight. The effect of this for the cooker user is that a smaller lifting force needs to be applied onto the cooker lid 80 in order to open the lid 80, resulting in cooker lid operation that requires less effort and energy to operate. This further provides for cooker users to quickly and easily vary the temperature under the cooker lid 80, amongst other benefits, with minimal effort by simply lifting the cooker lid 80 to the desired height and leaving the cooker lid 80 positioned at that height.

The present disclosure described above also relates generally to a method for easily cleaning an outdoor cooker 10. To clean out an outdoor cooker 10 of the present disclosure, both cooker racks are connected to the lifting mechanism 50 via a connective device 58 by the cooker user and the racks are then raised by operating the lifting mechanism 50, lifting both cooker racks out from the outdoor cooker body. When both cooker racks are lifted out from the cooker body, there is a gap between the lower cooker rack 40 and the bottom of the cooker body 14 where debris may have accumulated during operation of the outdoor cooker 10. The cooker user has easy access to this debris at the bottom of the outdoor cooker body 14 through a side door 18 on the firebox 13 that opens into the cooker body 12 below the racks. The side door 18 may have a plurality of vents (not shown) which may be opened and closed to adjust cooker temperature and heat flow, or may include a forced air venturi air supply. The opening in the side door 18 allows for quick and easy cleaning by the cooker user by simply inserting what is known in the art as an ash hoe or similar object into the cooker body 12 and scraping material into the firebox 13 for later removal or out the side of the cooker body 12 directly. This allows the cooker user to clean out the cooker 10 as needed while fats are still warm, liquid and easily removable, without having to physically grab and lift the cooker racks out and allows the cooker user to further clean out the outdoor cooker 10 by removing ash and other objects from the cooker body 12 without having to clean around cooker racks or other hot objects. Alternatively, the illustrated clean out tray 268 can be used. Tray 268 may be slid out, cleaned and returned to the cooker.

The present disclosure further allows the cooker user to clean out the outdoor cooker 10 during cooker use by simply following the same steps above instead of having to remove the food from the cooking surface before cooker rack lifting, allowing the cooker user to make full use of the cooking space within the outdoor cooker 10 by allowing the cooker user to fill the outdoor cooker 10 with multiple cooker racks. While previous disclosures have taught how to lift a single cooker rack out of an outdoor cooker, this disclosure further teaches how to lift and use multiple cooker racks inside the outdoor cooker, maximizing the efficiency and volume of the cooking area without having to sacrifice access to the inside of the outdoor cooker body 12. The firebox 13 may further be more easily cleaned by simply removing and dumping the debris out from a fire basket located on top of an elevated grate within the firebox 13 that housed the combustible fuel source, instead of having to clean out the entire firebox 13. In addition, optional drip trays 341 and ash tray 300 may further ease the cleaning of firebox 13.

The present disclosure described above further relates to the ability of a cooker user to move an upper cooker rack 30 relative to a fire when using the cooker 10 as a grill. During this type of usage, the combustible fuel source may be placed and combusted within the cooker body 12, directly below the upper cooker rack 30. One method of placing the combustible fuel source into the cooker body 12 is to that the fuel source into a fire basket or in-chamber tray 294 as shown in FIG. 3. Tray 294 might be supported on ledge 70, or on lower rack 40, for example. By having a lower cooker rack 40 that is easily removable, a fuel source may be brought immediately under or offset from food placed upon the upper cooker rack 30 to cook food, reducing the need to build a large-scale fire in the firebox 13 for a small-scale cooking job and allowing the cooker user to either cook directly below the food or indirectly or offset from the food. However, the ability of the cooker user to raise the upper cooker rack 30 out from the cooker body 12 allows the cooker user to build both larger and smaller sized fires within the cooker body 12 and to move the food towards and away from the fire as necessary. The cooker user is still free to cook using heat combusted from materials within the firebox. By incorporating a neutral-stop braking device 129 into the lifting mechanism 50, the present disclosure allows a user to not only lift racks out from the cooker, but further allows the cooker user to leave those racks positioned at some height relative the outdoor cooker body 12 without the use of a locking device that may require an extra hand or extra effort to keep the cooker rack in place. This is beneficial to the cooker user not only as an energy saving device, but also in the case of situations where the food products need to be removed from the heat with some urgency. In the event that the temperature within the outdoor cooker 10 gets too hot or that the combustible material flares up creating a hazard, the cooker user can quickly and safely remove the food from the heat source and leave it away from the heat without having to reach into the heat source to lock the racks in place. Thus, the present disclosure not only saves time and effort, but it further provides safety for the cooker user.

Yet another level of variability arising from the present disclosure is that of the combination of the double-walled firebox 13, double walled lid 80 and double walled base 81, and the ability to use the lower cooker rack 40 to place and burn combustible fuel sources; allowing the cooker user to grill either directly or offset from food placed on the upper cooker rack 30. The double-walled firebox 13 and cooker body 12 may be insulated with a high temperature fiberglass insulation 88 to protect the cooker user from burns resulting from contact with the firebox 13, as well as providing a more efficient means for burning combustible fuel sources within the firebox 13. In other words, the double walled construction and insulation allows for a substantial reduction in fuel use for a cooking job, and extend the times between refueling. In addition, allowing the cooker user to have access to both the upper and lower cooker racks, the user is further able to use the lifting mechanism 50 to lift out the upper cooker rack 30, place any desired combustible fuel source upon the lower cooker rack 40 and ignite it, with full access by the user to the upper cooker rack 30 once lowered from the lifting mechanism 50.

A further level of variability arises from the locations of the multiple cooking racks within the cooker body 12. By having an upper cooker rack 30 and lower cooker rack 40, the upper cooker rack 30 necessarily is located in a higher temperature zone as heat emanating from the combustible heat source necessarily rises. Thus, food that needs to be cooked more quickly may be placed upon the upper cooker rack 30, while food that needs to be cooked more slowly may be placed upon the lower cooker rack 40. This is of particular advantage to those cooker users who may be using the outdoor cooker 12 in cooking contests.

The outdoor cooker 10 may further be mounted onto a trailer 110 for easy travel over long-distances. As one application of the present invention is larger-scale, outdoor cookers, there may be a need to transport the outdoor cooker 10 to a plurality of venues, particularly if the outdoor cooker 10 is to be used in a commercial capacity. By adding the ability to trailer the cooker 10, considerable efforts to load and unload the outdoor cooker 10 onto an independent trailer or into a truck bed are no longer needed, a user can simply place the trailer tongue 118 onto the trailer hitch of the vehicle used to transport the cooker and trailer the cooker 10 where it is desired to be. Once the user arrives, the trailer 110 can easily be moved into place and the trailer tongue 118 removed from the trailer 110 for maximum transportability and access around the outdoor cooker 10. However, those skilled in the art may recognize that a plurality of other devices may be attached to the outdoor cooker 10 for easier movement, such as casters, but that no such feature shall be a requisite for use of the outdoor cooker 10.

When using the forced air mechanism, especially in conjunction with the venturi air supply, a variable flow rate of air into the lower chamber 335 can be maintained by adjusting the position of plate 316 to further open or close venturi passages 320. Since substantially all of the air entering firebox 13 must travel up through openings in fire platform 336, a user can be somewhat assured that little to no supplied air will actually bypass the fire and contribute to cooling food being cooked. After the combustion gases are generated, they travel from upper chamber 332 into main cooking chamber 46 and eventually out of exhaust stacks 232. Those skilled in the art will appreciate that the versatility of outdoor cooker 10 allows for cooking in the main cooking chamber 46, cooking with the rotisserie 450 positioned in firebox 13, and even cooking on a secondary grate 338 within the upper chamber 332 of firebox 13. Thus, the cooker 10 of the present disclosure allows for a large variety of cooking options that include smoking, barbeque, direct grilling, indirect cooking and rotisserie cooking. Furthermore, cooker 10 has the versatility to cook in several different ways simultaneously and at different temperatures, and permits cooking on both large and small scales from one steak up to roasting two whole hogs.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

1. An outdoor cooker comprising:
a main cooking chamber defined by a base and a lid;
a firebox attached to one end of the base of the main cooking chamber;
an exhaust stack attached to an opposite end of the base of the main cooking chamber;
a forced air system with an outlet end that opens into the firebox and an inlet end that opens outside the firebox, and including a main passage and at least one venturi passage;
wherein the venturi passage is configured to generate a venturi flow into the firebox when air flows through the main passage into the firebox; and
the main passage has a supply port sized for connection to a fan.

2. The cooker of claim 1 wherein venturi air supply includes a first tube that includes the supply port and defines at least a segment of the main passage; and
an outer surface of the first tube defining a portion of the venturi passage.

3. The cooker of claim 2 wherein the venturi air supply includes a venturi flow adjuster that is movable between a closed position that closes the venturi passage and an open position.

4. The cooker of claim 3 wherein the venturi air supply includes an outer tube that surrounds the first tube;
the venturi flow adjuster includes a plate movably mounted on an outer surface of the first tube;
the plate is movable along a central axis between the closed position at which the plate contacts one end of the outer tube, and the open position out of contact with the outer tube; and
the plate being stoppable at a continuum of partially open positions between the closed position and the open position.

5. The cooker of claim 4 wherein the plate has internal threads mated to a set of external threads of the first tube; and
an electrical blower connected to the first tube.

6. The cooker of claim 5 wherein the firebox includes a fire grate platform and an internal divider that divides the firebox into a lower chamber fluidly connected to an upper chamber by flow openings in the fire grate platform; and
the outlet end opens into the lower chamber, and the upper chamber opens into the main cooking chamber.

7. The cooker of claim 6 wherein firebox includes a first access door with a vertical hinge axis, and a second access door with a horizontal hinge axis;
the venturi air supply is mounted in the first access door; and
a rotisserie spit support mounted to the second access door.

8. An outdoor cooker comprising:
a main cooking chamber defined by a base and a lid;
a firebox attached to one end of the base of the main cooking chamber;
an exhaust stack attached to an opposite end of the base of the main cooking chamber;
wherein the firebox includes a fire grate platform and an internal divider that divides the firebox into a lower chamber fluidly connected to an upper chamber by flow openings in the fire grate platform; and
an air supply passage opens into the lower chamber, and the upper chamber opens into the main cooking chamber.

9. The outdoor cooker of claim 8 wherein the divider includes a horizontal plate and a vertical plate;
the vertical plate separates a secondary cooking chamber from a burn area above the fire grate platform;
the horizontal plate separates the secondary cooking chamber from the lower chamber; and
the firebox includes an access door, and the air supply passage extends through the access door.

10. The outdoor cooker of claim 9 wherein internal divider includes a handle attached to the horizontal plate adjacent the access door;
the burn area opens through the base into the main cooking chamber; and
a secondary cooking grate positioned in the secondary cooking chamber.

11. The outdoor cooker of claim 10 including a venturi air supply with an outlet end that opens into the firebox and an inlet end that opens outside the firebox, and including a main passage and at least one venturi passage;
wherein the venturi passage is configured to generate a venturi flow into the lower chamber of the firebox when air flows through the main passage into the firebox; and
the main passage has a supply port sized for connection to a forced air supply device.

12. The outdoor cooker of claim 11 wherein the venturi air supply includes an outer tube that surrounds the first tube;
the venturi flow adjuster includes a plate movably mounted on an outer surface of the first tube;
the plate is movable along a central axis between the closed position at which the plate contacts one end of the outer tube, and the open position out of contact with the outer tube;
the plate being stoppable at a continuum of partially open positions between the closed position and the open position, and the plate has internal threads mated to a set of external threads of the first tube; and
an electrical blower connected to the first tube.

13. The outdoor cooker of claim 12 wherein the firebox includes a first access door with a vertical hinge axis, and a second access door with a horizontal hinge axis; and
a rotisserie spit support mounted to the second access door.

14. The outdoor cooker of claim 10 including a slidable grate movable between a first position closing the air supply passage, and a second position opening the air supply passage.

15. An outdoor cooker comprising:
a main cooking chamber defined by a base and a lid;
a firebox attached to one end of the base of the main cooking chamber;
an exhaust stack attached to an opposite end of the base of the main cooking chamber;
wherein the firebox includes a first access door with a vertical hinge axis, and a second access door with a horizontal hinge axis; and
a rotisserie spit support and a motor support mounted to opposite sides of the second access door.

16. The outdoor cooker of claim 15 including a rotisserie spit rotationally supported by the rotisserie spit bracket; and
the rotisserie spit having an end extending through the second access door and received in a motor supported on the motor support.

17. The outdoor cooker of claim 16 wherein the rotisserie spit has a horizontal orientation perpendicular to the horizontal hinge axis when the second access door is in a closed position.

18. The outdoor cooker of claim 17 wherein the firebox includes a fire grate platform and an internal divider that divides the firebox into a lower chamber fluidly connected to an upper chamber by flow openings in the fire grate platform;
an air supply passage opens into the lower chamber;
the upper chamber includes a burn area above the fire grate platform that opens into the base of the main cooking chamber, and a secondary cooking area with a grate between the first access door and the burn area; and
the rotisserie spit is positioned in the upper chamber.

19. The outdoor cooker of claim 18 wherein the air supply passage is a portion of a venturi air supply with an outlet end that opens into the firebox and an inlet end that opens outside the firebox, and including a main passage and at least one venturi passage;
wherein the venturi passage is configured to generate a venturi flow into the lower chamber of the firebox when air flows through the main passage into the firebox; and
the main passage has a supply port sized for connection to a forced air supply device.

20. The cooker of claim 19 wherein the venturi air supply includes an outer tube that surrounds the first tube;
the venturi flow adjuster includes a plate movably mounted on an outer surface of the first tube;
the plate is movable along a central axis between the closed position at which the plate contacts one end of the outer tube, and the open position out of contact with the outer tube;
the plate being stoppable at a continuum of partially open positions between the closed position and the open position, and the plate has internal threads mated to a set of external threads of the first tube; and
an electrical blower connected to the first tube.
